(19) United States
(12) Patent Application Publication
(10) Pub. No.: US 2026/0073557 A1
(43) Pub. Date: Mar. 12, 2026

(54) VEHICLE CONTROL DEVICE, VEHICLE CONTROL METHOD, AND NON-TRANSITORY COMPUTER-READABLE STORAGE MEDIUM STORING A COMPUTER PROGRAM

(71) Applicant: HONDA MOTOR CO., LTD., Tokyo (JP)

(72) Inventor: Shota ISHIKAWA, Tokyo (JP)

(21) Appl. No.: 19/250,082

(22) Filed: Jun. 26, 2025

(30) Foreign Application Priority Data
Jun. 28, 2024 (JP) 2024-105715

(51) Int. Cl. G06T 7/73; B62D 15/02

(52) U.S. Cl. CPC G06T 7/74; B62D 15/025; G06T 2207/30256; G06T 2207/30261

(57) ABSTRACT

A vehicle control device generates a travel potential field based on an input image, generates a target trajectory based on a gradient of the travel potential, and operates an electric power steering device based on the target trajectory. The vehicle control device executes the processing of: setting a low-potential point at a position within a central region of the input image, the position being determined based on reference object information; setting a first high-potential point in a region of the input image where an obstacle appears; setting a value of the travel potential at the low-potential point to a first set value; setting a value of the travel potential at the first high-potential point to a second set value; and generating the travel potential field by interpolating a value of the travel potential, in a region between the low-potential point and the first high-potential point in the input image.

This application is based on and claims the benefit of priority from Japanese Patent Application No. 2024-105715, filed on 28 Jun. 2024, the content of which is incorporated herein by reference.

### BACKGROUND OF THE INVENTION

### Field of the Invention

The present invention relates to a vehicle control device, a vehicle control method, and a storage medium. More specifically, the present invention relates to a vehicle control device, a vehicle control method, and a storage medium, configured to control a host vehicle, based on an image captured by a camera.

### Related Art

In recent years, efforts to provide access to sustainable transportation systems that take into consideration individuals in vulnerable positions among road users have been gaining momentum. In order to realize such systems, research and development has been focused on improving the safety and convenience of traffic through the development of preventive safety technologies.

For example, Patent Document 1 discloses a preventive safety technology that performs driving control of a host vehicle, based on a so-called potential method. Here, the potential method refers to a method of defining a potential function (hereinafter also referred to as a “potential field”) in consideration of obstacles or the like present around the host vehicle, and generating a target trajectory of the host vehicle in accordance with the gradient of this potential function.
Patent Document 1: PCT International Publication No. WO 2018/131090

### SUMMARY OF THE INVENTION

In the vehicle control device disclosed in Patent Document 1, the shape of the travel path on which the host vehicle travels, and the status of surrounding objects, are recognized by using a plurality of external sensors such as a camera, a radar device, and a LiDAR device, as well as map information. Based on this recognition result, the vehicle control device determines the shape of the potential function. Therefore, the in-vehicle computer that generates the potential function and the target trajectory tends to bear a high processing load in order to integrate outputs from a plurality of external sensors and map information.

An object of the present invention is to provide a vehicle control device, a vehicle control method, and a storage medium, which are configured to control a vehicle with a reduced processing load, based on an image obtained by a camera, and contribute to the development of sustainable transportation systems.

(1) A vehicle control device (for example, a vehicle control device 1 described below) according to the present invention includes: an input image acquirer (for example, an input image acquisition unit 2 described below) configured to acquire, as an input image, an image captured by a camera (for example, an in-vehicle camera C described below) directed forward as viewed from a host vehicle (for example, a vehicle V described below); a travel potential field generator (for example, a travel potential field generation unit 3 described below) configured to generate a travel potential field indicating a distribution of travel potential with respect to a future travel position of the host vehicle, based on the input image; a target trajectory generator (for example, a target trajectory generation unit 4 described below) configured to generate a target trajectory of the host vehicle, based on a gradient of the travel potential in the travel potential field; and a travel controller (for example, a travel control unit 5 described below) configured to operate a steering mechanism (for example, an electric power steering device 9 described below), based on the target trajectory, in which the travel potential field generator is configured to execute the processing of:
extracting, from the input image, reference object information regarding a position of a reference object or a boundary of the reference object; setting a low-potential point at a position within a central region (for example, a central region CC described below) of the input image, the position being determined based on the reference object information; identifying, in the input image, a position of an obstacle that obstructs safe travel of the host vehicle; setting a first high-potential point in a region of the input image where the obstacle appears; setting a value of the travel potential at the low-potential point to a first set value; setting a value of the travel potential at the first high-potential point to a second set value greater than the first set value; and generating the travel potential field by interpolating a value of the travel potential, in a region between the low-potential point and the first high-potential point in the input image, using a value between the first set value and the second set value.

(2) In this case, it is preferable that the travel potential field generator is configured to: acquire, as the reference object information, a position of a fitting line (for example, a left-sky fitting line Fa1 described below) of a left-sky boundary line (for example, a left-sky boundary line La1 described below), and a position of a fitting line (for example, a right-sky fitting line Fa2 described below) of a right-sky boundary line (for example, a right-sky boundary line La2 described below), in the input image; and set the low-potential point at an intersection point (for example, an intersection point Pa described below) of the fitting line of the left-sky boundary line and the fitting line of the right-sky boundary line, in a case where the intersection point exists within the central region.

(3) In this case, it is preferable that the travel potential field generator is configured to: acquire, as the reference object information, a position of a fitting line (for example, a left-road fitting line Fb1 described below) of a left-road boundary line, and a position of a fitting line (for example, a right-road fitting line Fb2 described below) of a right-road boundary line, in the input image; and set the low-potential point at an intersection point of the fitting line of the left-road boundary line and the fitting line of the right-road boundary line, in a case where the intersection point (for example, an intersection point Pb described below) exists within the central region.

(4) In this case, it is preferable that the travel potential field generator is configured to: acquire, as the reference object information, a position of a road boundary line in the input image; and set the low-potential point at a topmost point (for example, a topmost point Pc described below) of the road boundary line in the input image, in a case where the topmost point exists within the central region.

(5) In this case, it is preferable that the travel potential field generator is configured to: acquire, as reference object information, a position of a left-sky fitting line of a left-sky boundary line in the input image, a position of a right-sky fitting line of a right-sky boundary line in the input image, a position of a left-road fitting line of a left-road boundary line in the input image, a position of a right-road fitting line of a right-road boundary line in the input image, and a position of a road boundary line in the input image; and set the low-potential point at a position determined based on two or more points that exist within the central region, the points including: an intersection point of the left-sky fitting line and the right-sky fitting line; an intersection point of the left-road fitting line and the right-road fitting line; and a topmost point of the road boundary line in the input image.

(6) In this case, it is preferable that the travel potential field generator is configured to: acquire, as the reference object information, a position of a preceding vehicle in the input image, in a case where the preceding vehicle is recognized as a tracking target within the central region.

(7) In this case, it is preferable that the travel potential field generator is configured to: acquire, as the reference object information, a position of a road boundary line or a position of a preceding vehicle recognized as a tracking target, in a case where the host vehicle is traveling on a road where the sky is blocked by an overhead structure.

(8) In this case, it is preferable that the travel potential field generator is configured to: set the value of the travel potential such that the gradient becomes steeper as the low-potential point is approached, within a low-potential range centered on the low-potential point; set the value of the travel potential such that the gradient becomes steeper as the first high-potential point is approached, within a first high-potential range centered on the first high-potential point; and set the value of the travel potential such that, outside the low-potential range and the first high-potential range, the gradient is constant and more gradual than within either range.

(9) In this case, it is preferable that the travel potential field generator is configured to further execute the processing of: identifying a position of a lane marking of the host vehicle in the input image; setting a second high-potential point in a region of the input image where the lane marking appears; setting a value of the travel potential at the second high-potential point to a third set value greater than the first set value; and generating the travel potential field by interpolating the value of the travel potential, in a region between the low-potential point and the second high-potential point in the input image, using a value between the first set value and the third set value.

(10) In this case, it is preferable that the travel potential field generator is configured not to set the second high-potential point in a case where the host vehicle is performing or scheduled to perform a lane change.

(1) In the present invention, the input image acquirer acquires, as an input image, an image captured by a camera that is directed forward as viewed from a host vehicle. The travel potential field generator generates a travel potential field indicating a distribution of travel potential with respect to a future travel position of the host vehicle, based on the input image. The target trajectory generator generates a target trajectory of the host vehicle, based on the gradient of the travel potential in the travel potential field. The travel controller operates a steering mechanism, based on the target trajectory. In the present invention, the travel potential field generator extracts reference object information regarding a predetermined reference object from the input image, sets a low-potential point at a position located within a central region of the input image and determined based on the reference object information, identifies the position of an obstacle in the input image, and further sets a first high-potential point in a region of the input image in which the obstacle appears. Furthermore, the travel potential field generator sets the travel potential at the low-potential point to a first set value, sets the travel potential at the first high-potential point to a second set value greater than the first set value, and generates the travel potential field for the input image by interpolating the value of the travel potential, in a region between the low-potential point and the first high-potential point, using a value between the first set value and the second set value. According to the present invention, it is possible to generate the travel potential field and the target trajectory solely based on the positions of the reference object and obstacles appearing in the input image, without using external sensors other than the camera or map information. As a result, the host vehicle can be controlled with a reduced processing load, thereby contributing to the development of sustainable transportation systems.

(2) In the present invention, the travel potential field generator acquires, as the reference object information, the position of a fitting line of a left-sky boundary line in the input image—that is, a boundary line between the sky and ground objects on the left side as viewed from the host vehicle (hereinafter also referred to as the “left-sky fitting line”)—and the position of a fitting line of a right-sky boundary line—that is, a boundary line between the sky and ground objects on the right side as viewed from the host vehicle (hereinafter also referred to as the “right-sky fitting line”). In a case where an intersection point of the left-sky fitting line and the right-sky fitting line exists within the central region, the travel potential field generator sets the intersection point as the low-potential point that serves as the endpoint of the target route. Therefore, according to the present invention, the travel potential field can be generated through simple computation on the input image.

(3) In the present invention, the travel potential field generator acquires, as the reference object information: the position of a fitting line of a left-road boundary line in the input image—that is, a left edge line of the road on which the host vehicle is traveling, as viewed from the host vehicle (hereinafter also referred to as the “left-road fitting line”)—and the position of a fitting line of a right-road boundary line—that is, a right edge line of the road on which the host vehicle is traveling, as viewed from the host vehicle (hereinafter also referred to as the “right-road fitting line”). In a case where an intersection point of the left-road fitting line and the right-road fitting line exists within the central region, the travel potential field generator sets the intersection point as the low-potential point that serves as the endpoint of the target route. Therefore, according to the present invention, the travel potential field can be generated through simple computation on the input image.

(4) In the present invention, the travel potential field generator acquires, as the reference object information, a position of a road boundary line in the input image (that is, a line combining the left-road boundary line and the right-road boundary line). In a case where a topmost point of the road boundary line in the input image exists within the central region, the travel potential field generator sets the topmost point as the low-potential point which serves as the endpoint of the target route. Therefore, according to the present invention, the travel potential field can be generated through simple computation on the input image.

(5) In the present invention, the travel potential field generator acquires, as the reference object information, the positions of a left-sky fitting line, a right-sky fitting line, a left-road fitting line, a right-road fitting line, and a road boundary line in the input image. The travel potential field generator sets the low-potential point, which serves as the endpoint of the target route, at a position determined based on two or more of the following points that exist within the central region: an intersection point of the left-sky fitting line and the right-sky fitting line;
an intersection point of the left-road fitting line and the right-road fitting line; and a topmost point of the road boundary line in the input image. Therefore, according to the present invention, the travel potential field can be generated through simple computation on the input image.

(6) In the present invention, in a case where a preceding vehicle recognized as a tracking target exists within the central region, the travel potential field generator acquires, as the reference object information, the position of the preceding vehicle in the input image, and sets the low-potential point, which serves as the endpoint of the target route, at a position determined based on the position of the preceding vehicle. Therefore, according to the present invention, a travel potential field that enables the host vehicle to automatically follow a preceding vehicle can be generated through simple computation performed on the input image.

(7) In the present invention, in a case where the host vehicle is traveling on a road where the sky is obstructed by an overhead structure—for example, inside a tunnel—that is, when the sky is hardly visible in the input image—the travel potential field generator acquires, as the reference object information, the position of a road boundary line or the position of a preceding vehicle recognized as a tracking target, and sets the position of the low-potential point based on the acquired position(s). Therefore, according to the present invention, even when the sky is not sufficiently captured in the input image, a low-potential point can be set to an appropriate position.

(8) In the present invention, the travel potential field generator sets the value of the travel potential as follows. Within a low-potential range centered on the low-potential point, the gradient becomes steeper as it approaches the center. Within a first high-potential range centered on the first high-potential point, the gradient also becomes steeper as it approaches the center. Outside both the low-potential range and the first high-potential range, the gradient is constant and more gradual than inside those ranges. According to the present invention, by generating a travel potential field through the above procedure, it is possible to generate, through simple computation, a travel potential field that enables a target route to be generated which avoids the first high-potential point where an obstacle exists and terminates at the low-potential point.

(9) In the present invention, the travel potential field generator sets a second high-potential point in a region of the input image in which a lane marking of the host vehicle appears. The travel potential field generator sets the value of the travel potential at the second high-potential point to a third set value greater than the first set value, and generates the travel potential field by interpolating the value of the travel potential, in a region between the low-potential point and the second high-potential point in the input image, using a value between the first set value and the third set value. According to the present invention, by generating the travel potential field through the procedure described above, it is possible to generate, through simple computation, a travel potential field that enables a target route to be generated which avoids both a first high-potential point where an obstacle exists and a second high-potential point where a lane marking exists, and which terminates at the low-potential point.

(10) As described above, when a second high-potential point is set at a position where a lane marking of the host vehicle exists, a target route that avoids the lane marking is generated. Therefore, in the present invention, the travel potential field generator is configured not to set the second high-potential point as described above in a case where the host vehicle is performing or scheduled to perform a lane change. According to the present invention, it is therefore possible to generate, through simple computation, a travel potential field that enables a target route to be generated which crosses a lane marking.

### BRIEF DESCRIPTION OF THE DRAWINGS

FIG. 1 is a schematic diagram illustrating a configuration of a vehicle equipped with a vehicle control device according to an embodiment of the present invention;

FIG. 2 is a functional block diagram of the vehicle control device;

FIG. 3 is a schematic diagram illustrating a travel potential field generated by a travel potential field generation unit;

FIG. 4 is a flowchart illustrating specific steps of travel potential field generation processing;

FIG. 5 is a diagram illustrating the procedure of low-potential point search processing;

FIG. 6 is a diagram illustrating the procedure of high-potential point search processing;

FIG. 7 is a diagram illustrating an example of setting values of travel potential in a region including a first high-potential point and a low-potential point; and

FIG. 8 is a diagram illustrating an example of a travel potential field generated by the travel potential field generation processing.

### DETAILED DESCRIPTION OF THE INVENTION

Hereinafter, a vehicle control device according to an embodiment of the present invention will be described with reference to the drawings.

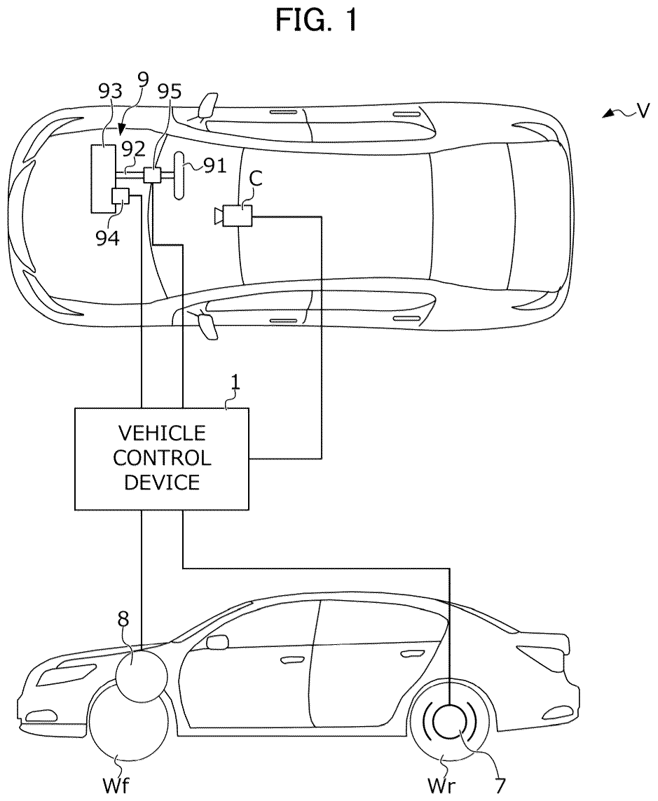

FIG. 1 is a schematic diagram illustrating the configuration of a vehicle V equipped with a vehicle control device 1 according to the present embodiment. The upper part of FIG. 1 illustrates a plan view of the vehicle V, and the lower part of FIG. 1 illustrates a side view thereof. In the following description, the vehicle V is assumed to be a right-hand drive four-wheeled vehicle in which the driver's seat is located on the right side in the vehicle width direction as viewed in the direction of travel; however, the present invention is not limited thereto. The vehicle V may be a left-hand drive four-wheeled vehicle in which the driver's seat is located on the left side in the vehicle width direction as viewed in the direction of travel.

The vehicle V includes: an electric power steering device 9 serving as a steering mechanism configured to steer the left and right front wheels Wf; a power plant 8 serving as a travel drive device configured to generate driving force to rotate the front wheels Wf, which are drive wheels of the vehicle V; a braking device 7 configured to generate braking force to stop the rotation of the front wheels Wf and rear wheels Wr; an in-vehicle camera C configured to capture images around the vehicle V; and a vehicle control device 1 configured to control the electric power steering device 9, the power plant 8, and the braking device 7, based on images captured by the in-vehicle camera C.

The electric power steering device 9 includes: a pinion shaft 92 extending from a steering wheel 91 that receives steering input from the driver; a gear box 93 connecting the pinion shaft 92 to the left and right front wheels Wf; an electric motor 94 provided in the gear box 93; and a steering sensor 95 configured to detect the steering angle of the steering wheel 91.

The gear box 93 includes a rack shaft that extends in the vehicle width direction and engages with the pinion shaft 92, and tie rods that connect both ends of the rack shaft to the left and right front wheels Wf. The gear box 93 converts rotational motion of the steering wheel 91 caused by the driver's steering operation into lateral motion along the vehicle width direction, thereby turning the left and right front wheels Wf in the direction of travel. The electric motor 94 rotates in accordance with a control signal output from the vehicle control device 1, generating a driving force to assist the driver's steering operation or to automatically steer the front wheels Wf regardless of the driver's operation. The steering sensor 95 detects the steering angle of the steering wheel 91 and sends a signal corresponding to the detected value to the vehicle control device 1.

The power plant 8 is a driving force generation source configured to generate driving force to rotate the front wheels Wf and move the vehicle V forward or backward along the direction of travel, based on acceleration and deceleration inputs from the driver via an accelerator pedal (not illustrated), or based on control signals output from the vehicle control device 1. In the following description, the power plant 8 is assumed to be a drive motor that generates driving force by consuming electric power supplied from a high-voltage battery or a fuel cell stack (not illustrated); however, the invention is not limited thereto. The power plant 8 may alternatively be an engine that generates driving force by consuming fuel stored in a fuel tank (not illustrated), or a transmission configured to change and transmit the output of the engine to the front wheels Wf.

The braking device 7 includes: a disc brake device configured to generate braking force to decelerate or stop the rotation of the wheels Wf and Wr, mainly during travel, by clamping discs provided on the axles of the respective wheels Wf and Wr, based on a braking operation performed by the driver via a brake pedal (not illustrated) or a control signal output from the vehicle control device 1; and a parking brake configured to generate braking force to maintain the stopped state of rotation of the wheels Wr and Wf, mainly during parking.

The in-vehicle camera C is directed forward along the direction of travel as viewed from the vehicle V. In the present embodiment, the in-vehicle camera C is provided at the center of the vehicle width direction of the vehicle body of the vehicle V; however, the invention is not limited thereto.

The vehicle control device 1 controls the electric power steering device 9, the power plant 8, and the braking device 7, based on the images of the forward side of the vehicle V captured by the in-vehicle camera C. The vehicle control device 1 is a computer that includes hardware components such as: a processor such as a CPU; an auxiliary storage such as an HDD or SSD configured to store a program for causing the processor to execute the travel potential field generation processing described later; and a main storage such as RAM configured to temporarily store data required for the processor to execute the program.

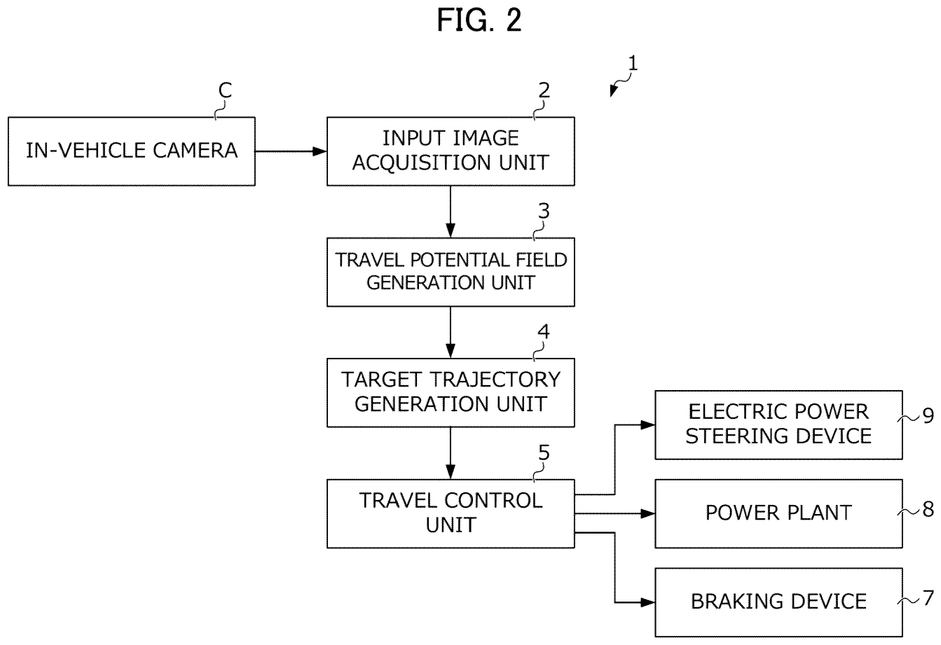

FIG. 2 is a functional block diagram of the vehicle control device 1. Through the hardware configuration described above, the vehicle control device 1 is functionally composed of: an input image acquisition unit 2, a travel potential field generation unit 3, a target trajectory generation unit 4, and a travel control unit 5.

The input image acquisition unit 2 acquires, as an input image, an image of the forward side of the vehicle V captured by the in-vehicle camera C. The input image acquisition unit 2 transmits information regarding the acquired input image to the travel potential field generation unit 3.

The travel potential field generation unit 3 generates a travel potential field indicating the distribution of travel potential on the input image with respect to a future travel position of the vehicle V (namely, the distribution of travel potential on two-dimensional image coordinates defined by the input image) based on the input image transmitted from the input image acquisition unit 2. The travel potential field generation unit 3 transmits information regarding the generated travel potential field to the target trajectory generation unit 4.

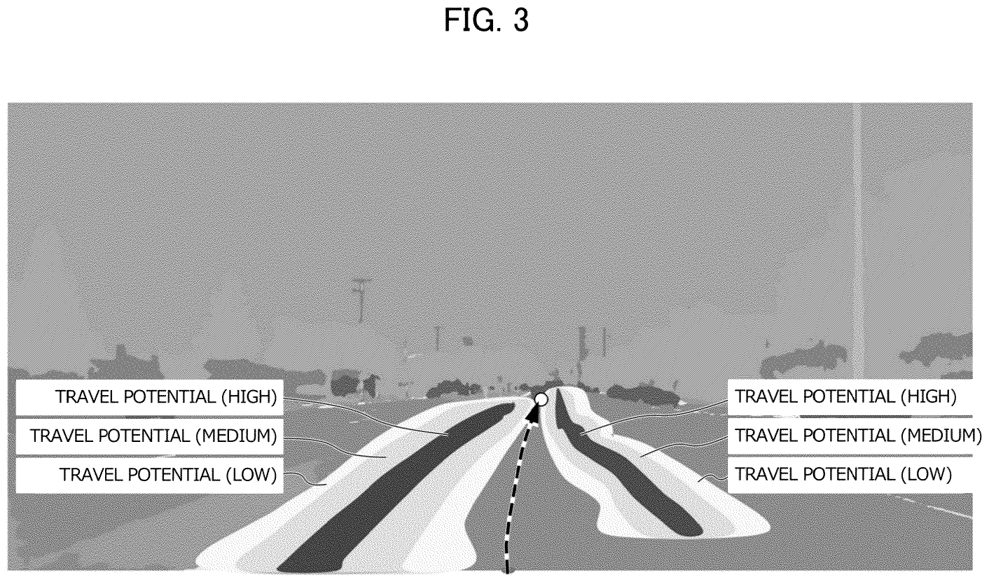

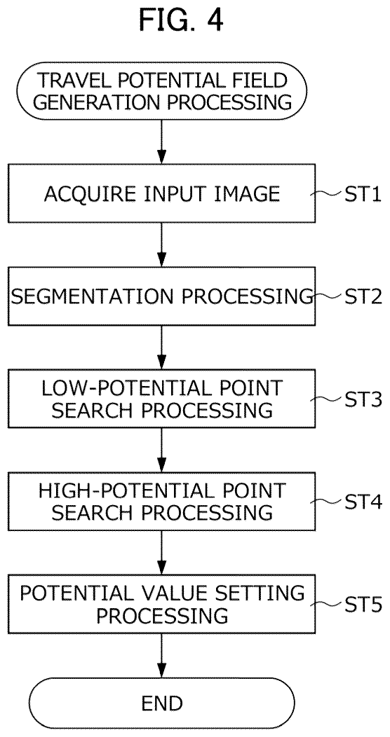

FIG. 3 is a schematic diagram illustrating a travel potential field generated by the travel potential field generation unit 3. In FIG. 3, the input image is used as a background, and the values of the travel potential are illustrated using different colors. More specifically, darker colors represent higher values of the travel potential. Also in FIG. 3, the point where the value of the travel potential is the smallest (i.e., the minimum-potential point) is indicated by a white circle. As illustrated in FIG. 3, the travel potential field is a scalar function of travel potential defined over two-dimensional image coordinates. The specific procedure for generating the travel potential field by the travel potential field generation unit 3 will be described later with reference to FIGS. 4 to 8.

Returning to FIG. 2, the target trajectory generation unit 4 calculates a gradient of the travel potential field generated by the travel potential field generation unit 3. Based on this gradient and the current steering angle or the like of the vehicle V, the target trajectory generation unit 4 generates a target trajectory on the image coordinates for the vehicle V. The target trajectory generation unit 4 transmits information regarding the generated target trajectory to the travel control unit 5. Here, the gradient of the travel potential field corresponds to a vector function representing the partial derivatives of the travel potential field with respect to image coordinate components defined in two-dimensional image space. Thus, the target trajectory generation unit 4 generates a target trajectory (see the bold broken line in FIG. 3) that starts from the front of the vehicle V and follows the valley of the travel potential toward the minimum-potential point.

The travel control unit 5 operates the electric power steering device 9, the power plant 8, and the braking device 7, based on the target trajectory generated by the target trajectory generation unit 4. More specifically, the travel control unit 5 operates the electric power steering device 9, the power plant 8, and the braking device 7 such that the vehicle V travels along the target trajectory defined on the image coordinates.

FIG. 4 is a flowchart illustrating the specific procedure of the travel potential field generation processing. The travel potential field generation processing illustrated in FIG. 4 is repeatedly executed by the travel potential field generation unit 3 during travel of the vehicle V, at predetermined control cycles.

First, in Step ST1, the travel potential field generation unit 3 acquires an input image transmitted from the input image acquisition unit 2, and proceeds to Step ST2.

Next, in Step ST2, the travel potential field generation unit 3 executes the segmentation processing on the input image acquired in Step ST1 to classify the objects appearing in the input image into a plurality of classes, thereby generating an image (hereinafter referred to as an “edge image”) in which the boundaries between classes are extracted. The processing then proceeds to Step ST3.

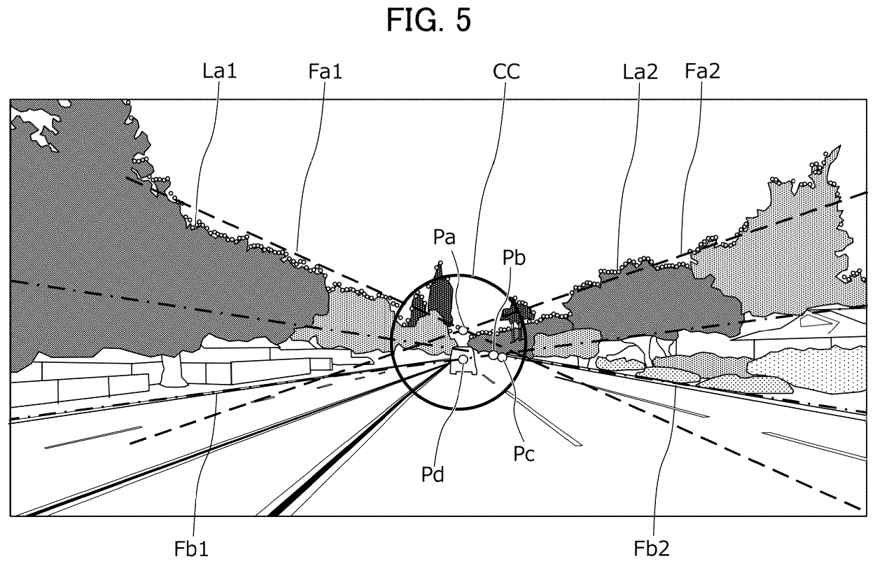

Next, in Step ST3, the travel potential field generation unit 3 executes the low-potential point search processing, in which a position of a low-potential point is searched on the image coordinates, based on the edge image extracted from the input image, information on the respective classes of objects appearing in the input image (hereinafter referred to as “class information”), and the like. The processing then proceeds to Step ST4. Here, the low-potential point refers to the point on the image coordinates at which the value of the travel potential becomes the minimum, and serves as the endpoint of the target trajectory, as illustrated in FIG. 3. Details of the low-potential point search processing will be described below with reference to FIG. 5.

FIG. 5 is a diagram illustrating an example of the input image, illustrating the procedure of the low-potential point search processing. First, the travel potential field generation unit 3 extracts, as reference object information, information regarding a position on the image coordinates of a reference object, which is predetermined for setting the low-potential point, or information regarding a boundary line of the reference object, from the edge image and class information. Next, the travel potential field generation unit 3 sets the low-potential point at a position within a central region CC, which includes the center of the image coordinates, and determined based on the extracted reference object information. A plurality of Examples of the low-potential point search processing will be described below.

### Example 1

In Example 1, the travel potential field generation unit 3 sets the position of the low-potential point using, as a reference object, an object classified as “sky” among the plurality of objects appearing in the input image. In this case, the travel potential field generation unit 3 acquires, as reference object information, the position of a fitting line Fa1 of a left-sky boundary line La1 and the position of a fitting line Fa2 of a right-sky boundary line La2, from the edge image and the class information. Here, the left-sky boundary line La1 refers to a boundary line between the sky and ground objects on the left side of the input image as viewed from the vehicle V, and the right-sky boundary line La2 refers to a boundary line between the sky and ground objects on the right side. The fitting line of the left-sky boundary line (hereinafter also referred to as the “left-sky fitting line”) Fa1 refers to a line obtained by fitting the left-sky boundary line La1, based on a known algorithm, for example, by a linear function. The fitting line of the right-sky boundary line (hereinafter also referred to as the “right-sky fitting line”) Fa2 refers to a line obtained by fitting the right-sky boundary line La2, based on a known algorithm, for example, by a linear function.

In a case where the intersection point Pa of the left-sky fitting line Fa1 and the right-sky fitting line Fa2 thus obtained exists within the predetermined central region CC, the travel potential field generation unit 3 sets this intersection point Pa as the low-potential point. In a case where the intersection point Pa does not exist within the central region CC, the travel potential field generation unit 3 sets the position of the low-potential point, based on other Examples (e.g., Examples 2 to 5).

In a case where the vehicle V is traveling on a road where the sky is blocked by an overhead structure (for example, when the vehicle V is traveling inside a tunnel), the left-sky fitting line Fa1 and the right-sky fitting line Fa2 cannot be obtained. Accordingly, in such cases, the travel potential field generation unit 3 sets the position of the low-potential point, based on other Examples (e.g., Examples 2 to 5).

### Example 2

In Example 2, the travel potential field generation unit 3 sets the position of the low-potential point using, as a reference object, an object classified as “road” among a plurality of objects appearing in the input image. In this case, the travel potential field generation unit 3 acquires, as the reference object information, the position of a fitting line Fb1 of a left-road boundary line and the position of a fitting line Fb2 of a right-road boundary line from the edge image, the class information, and the like. Here, the left-road boundary line refers to the left edge line of the road on which the vehicle V is traveling, as viewed from the vehicle V in the input image. The right-road boundary line refers to the right edge line of the road on which the vehicle V is traveling, as viewed from the vehicle V in the input image. The fitting line of the left-road boundary line (hereinafter also referred to as the “left-road fitting line”) Fb1 refers to a line obtained by fitting the left-road boundary line, based on a known algorithm, for example, by a linear function. The fitting line of the right-road boundary line (hereinafter also referred to as the “right-road fitting line”) Fb2 refers to a line obtained by fitting the right-road boundary line, based on a known algorithm, for example, by a linear function. In the example illustrated in FIG. 4, since the left and right-road boundary lines substantially overlap with the fitting lines Fb1 and Fb2, only the fitting lines Fb1 and Fb2 are illustrated.

In a case where the intersection point Pb of the left-road fitting line Fb1 and the right-road fitting line Fb2 thus obtained exists within the central region CC, the travel potential field generation unit 3 sets this intersection point Pb as the low-potential point. In a case where the intersection point Pb does not exist within the central region CC, the travel potential field generation unit 3 sets the position of the low-potential point, based on other Examples such as Examples 1 and 3 to 5.

### Example 3

In Example 3, the travel potential field generation unit 3 sets the position of the low-potential point using, as a reference object, an object classified as “road” among a plurality of objects appearing in the input image, similarly to Example 2. In this case, the travel potential field generation unit 3 acquires, as the reference object information, the position of a road boundary line from the edge image and the class information. Here, the road boundary line refers to a line obtained by combining the left-road boundary line and the right-road boundary line described above.

In a case where the topmost point Pc of the road boundary line in the input image thus obtained exists within the central region CC, the travel potential field generation unit 3 sets this topmost point Pc as the low-potential point. In a case where the topmost point Pc does not exist within the central region CC, the travel potential field generation unit 3 sets the position of the low-potential point, based on other Examples such as Examples 1, 2, 4, and 5.

### Example 4

In Example 4, the travel potential field generation unit 3 sets the position of the low-potential point using, as reference objects, objects classified as “sky” or “road” among a plurality of objects appearing in the input image. In this case, the travel potential field generation unit 3 acquires, as the reference object information, the positions of the left-sky fitting line Fa1, the right-sky fitting line Fa2, the left-road fitting line Fb1, the right-road fitting line Fb2, and the road boundary line, from the edge image, the class information, and the like.

The travel potential field generation unit 3 sets the low-potential point at a position determined based on two or more of the following points that exist within the central region CC: an intersection point Pa of the left-sky fitting line Fa1 and the right-sky fitting line Fa2; an intersection point Pb of the left-road fitting line Fb1 and the right-road fitting line Fb2; and a topmost point Pc of the road boundary line. More specifically, the travel potential field generation unit 3 sets the low-potential point, for example, at the geometric centroid of two or more of the points Pa, Pb, and Pc that exist within the central region CC.

### Example 5

In Example 5, the travel potential field generation unit 3 sets the position of the low-potential point using, as a reference object, an object classified as “preceding vehicle” among a plurality of objects appearing in the input image. In this case, the travel potential field generation unit 3 acquires, as the reference object information, the position of a preceding vehicle (more specifically, the position of a center point Pd of the preceding vehicle) from the edge image, the class information, and the like. Here, the preceding vehicle refers to a vehicle that travels in the same lane and in the same direction as the vehicle V and is located in front of the vehicle V.

In a case where the preceding vehicle thus extracted is recognized, by the processing (not illustrated), as a tracking target of the vehicle V, and the center point Pd of the preceding vehicle exists within the central region CC, the travel potential field generation unit 3 sets the center point Pd as the low-potential point. In a case where no preceding vehicle exists, or the preceding vehicle is not recognized as a tracking target, or the center point Pd does not exist within the central region CC, the travel potential field generation unit 3 sets the position of the low-potential point, based on other Examples such as Examples 1 to 4.

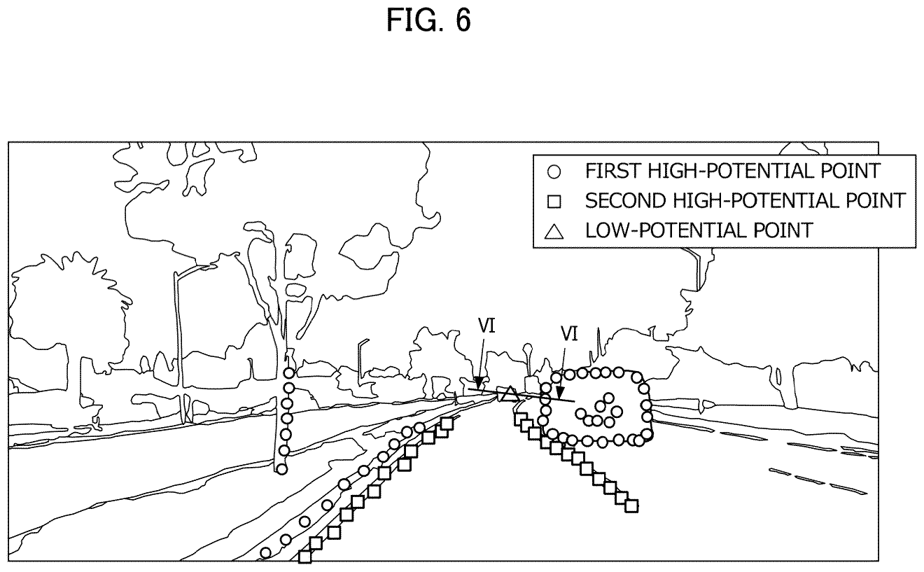

Returning to FIG. 4, in Step ST4, the travel potential field generation unit 3 executes the high-potential point search processing to search for the position of a high-potential point on the image coordinates, based on the edge image, the class information, and the like extracted from the input image. The processing then proceeds to Step ST5. Here, the high-potential point refers to a point on the image coordinates where the value of the travel potential reaches a local maximum value. Details of the high-potential point search processing will be described below with reference to FIG. 6.

FIG. 6 is a diagram illustrating an example of the input image, illustrating the procedure of the high-potential point search processing. First, the travel potential field generation unit 3 identifies, from the edge image, the class information, and the like, the positions on the image coordinates of obstacles that hinder the safe travel of the vehicle V. Here, the obstacles that hinder the safe travel of the vehicle V include, for example, other vehicles (excluding the preceding vehicle), curbs, street trees, and the like. Next, the travel potential field generation unit 3 sets first high-potential points in the region of the image coordinates where the identified obstacles appear, as indicated by the circles in FIG. 6.

The travel potential field generation unit 3 further identifies, from the edge image, the class information, and the like, the positions on the image coordinates of lane markings for the vehicle V. Next, as indicated by squares in FIG. 6, the travel potential field generation unit 3 sets second high-potential points in the region of the image coordinates where the identified lane markings appear.

These lane markings, unlike the obstacles set as the first high-potential points, do not in themselves constitute obstructions to the safe travel of the vehicle V. However, the vehicle V crossing over the lane markings while traveling may pose a threat to the safe travel of other vehicles. Therefore, the travel potential field generation unit 3 sets the second high-potential points at such lane markings. However, setting the second high-potential points at such lane markings may disable the vehicle V from traveling across the lane marking and ultimately from performing a lane change. Accordingly, when the vehicle V is currently performing or is scheduled to perform a lane change, it is preferable that the travel potential field generation unit 3 is configured not to set the second high-potential points.

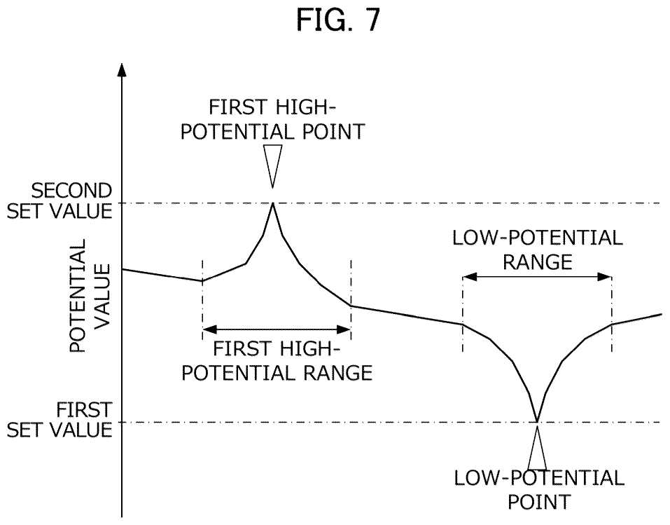

Returning to FIG. 4, in Step ST5, the travel potential field generation unit 3 executes the travel potential value setting processing to set the values of the travel potential on the image coordinates, based on the positions of the low-potential point searched in Step ST3 and the high-potential points searched in Step ST4, thereby completing the processing illustrated in FIG. 4. The specific procedure of the travel potential value setting processing will be described below with reference to FIG. 7.

FIG. 7 is a diagram illustrating an example of how the values of the travel potential are set in a region including the first high-potential point and the low-potential point, as taken along the line VI-VI in FIG. 6.

First, the travel potential field generation unit 3 sets the value of the travel potential at the low-potential point to a first set value predetermined in advance, then sets the value of the travel potential at the first high-potential point to a second set value greater than the first set value, and sets the value at the second high-potential point to a third set value greater than the first set value. In the following description, a case is described in which the second set value and the third set value are set to be equal in magnitude; however, the present invention is not limited thereto. The second set value and the third set value may also be set to different values.

Next, the travel potential field generation unit 3 interpolates the value of the travel potential, in a region between the low-potential point and the first high-potential point on the image coordinates, using a value between the first set value and the second set value, and also interpolates the value of the travel potential, in a region between the low-potential point and the second high-potential point, using a value between the first set value and the third set value.

More specifically, within a low-potential range centered on the low-potential point, the travel potential field generation unit 3 sets the value of the travel potential such that the gradient becomes steeper as approaching the low-potential point. Within a first high-potential range centered on the first high-potential point, the travel potential field generation unit 3 sets the value such that the gradient becomes steeper as approaching the first high-potential point. Similarly, within a second high-potential range centered on the second high-potential point, the travel potential field generation unit 3 sets the value such that the gradient becomes steeper as approaching the second high-potential point.

Next, the travel potential field generation unit 3 sets the value of the travel potential such that the gradient outside the low-potential range, the first high-potential range, and the second high-potential range is constant and is more gradual than inside the low-potential range, the first high-potential range, and the second high-potential range. The travel potential field generation unit 3 sets the values of the travel potential across the entire area of the image coordinates in accordance with the procedure described above, thereby generating the travel potential field.

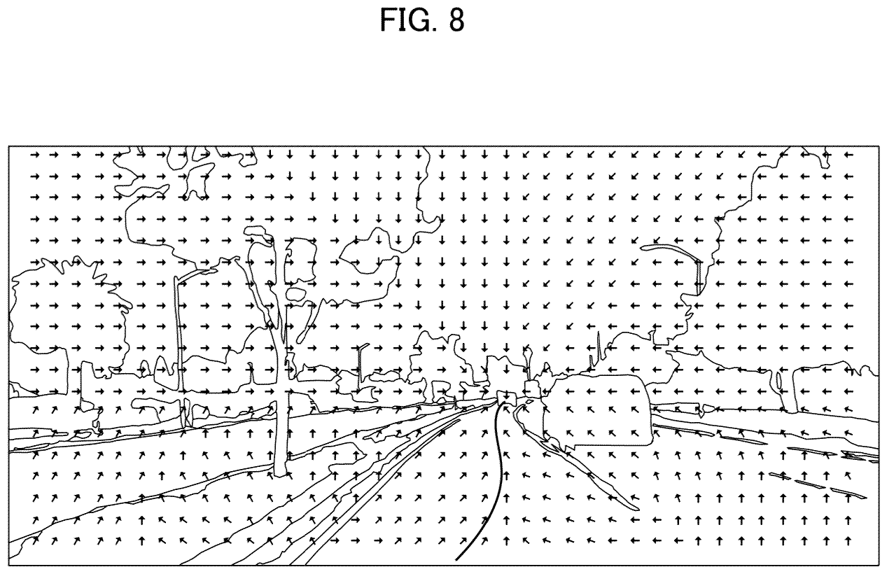

FIG. 8 is a diagram illustrating an example of a travel potential field generated by the travel potential field generation processing described above. In FIG. 8, the gradient of the travel potential field, which is a vector function, is indicated by arrows. In the example of FIG. 8, for the purpose of visual clarity, only the second high-potential points are set, and the first high-potential points are not set.

In the example illustrated in FIG. 8, ridge lines of the travel potential peaks are formed along two travel lanes extending from both the left and right sides of the vehicle toward the center of the input image. Therefore, in the example illustrated in FIG. 8, a valley line of travel potential is formed between the two travel lanes, extending toward the center of the input image. Accordingly, under the travel potential field as illustrated in FIG. 8, the target trajectory generation unit 4 generates a target trajectory that extends along the valley line of the travel potential field, as indicated by the bold broken line in FIG. 8.

According to the vehicle control device 1 of the present embodiment, the following effects can be achieved.

(1) The input image acquisition unit 2 acquires an input image captured by the in-vehicle camera C that is directed forward as viewed from the vehicle V. The travel potential field generation unit 3 generates a travel potential field indicating a distribution of travel potential with respect to a future travel position of the vehicle V, based on the input image. The target trajectory generation unit 4 generates a target trajectory of the vehicle V, based on a gradient of the travel potential in the travel potential field. The travel control unit 5 operates the electric power steering device 9, the power plant 8, and the braking device 7, based on the target trajectory. Further, the travel potential field generation unit 3 extracts reference object information regarding a predetermined reference object from the input image, sets a low-potential point at a position within the central region CC of the input image and determined based on the reference object information, identifies the position of an obstacle in the input image, and sets a first high-potential point in a region of the input image where the obstacle appears. The travel potential field generation unit 3 sets the value of the travel potential at the low-potential point to a first set value, sets the value of the travel potential at the first high-potential point to a second set value greater than the first set value, and generates a travel potential field for the input image by interpolating the values of the travel potential, in the region between the low-potential point and the first high-potential point in the input image, using values between the first set value and the second set value. As described above, according to the present embodiment, the travel potential field and the target trajectory can be generated solely based on the positions of the reference object and obstacles appearing in the input image, without using external sensors other than the in-vehicle camera C or map information. Therefore, the host vehicle can be controlled with a reduced processing load, and this contributes to the development of sustainable transportation systems.

(2) The travel potential field generation unit 3 acquires, as the reference object information, the positions of the left-sky fitting line and the right-sky fitting line in the input image. In a case where the intersection point Pa of the left-sky fitting line and the right-sky fitting line exists within the central region CC, the travel potential field generation unit 3 sets this intersection point Pa as a low-potential point that serves as the endpoint of the target route. Therefore, according to the present invention, the travel potential field can be generated through simple computation performed on the input image.

(3) The travel potential field generation unit 3 acquires, as the reference object information, the positions of the left-road fitting line and the right-road fitting line in the input image. In a case where the intersection point Pb of the left-road fitting line and the right-road fitting line exists within the central region CC, the travel potential field generation unit 3 sets this intersection point Pb as a low-potential point that serves as the endpoint of the target route. Therefore, according to the present invention, the travel potential field can be generated through simple computation performed on the input image.

(4) The travel potential field generation unit 3 acquires, as the reference object information, the position of a road boundary line in the input image. In a case where the topmost point Pc of the road boundary line in the input image exists within the central region CC, the travel potential field generation unit 3 sets this topmost point Pc as a low-potential point that serves as the endpoint of the target route. Therefore, according to the vehicle control device 1, the travel potential field can be generated through simple computation performed on the input image.

(5) The travel potential field generation unit 3 acquires, as the reference object information, the positions of the left-sky fitting line, the right-sky fitting line, the left-road fitting line, the right-road fitting line, and the road boundary line in the input image. The travel potential field generation unit 3 sets a low-potential point, which serves as the endpoint of the target route, at a position determined based on two or more of the following points that exist within the central region CC: an intersection point Pa of the left-sky fitting line and the right-sky fitting line, an intersection point Pb of the left-road fitting line and the right-road fitting line, and a topmost point Pc of the road boundary line in the input image. Therefore, according to the vehicle control device 1, the travel potential field can be generated through simple computation performed on the input image.

(6) In a case where a preceding vehicle, recognized as a tracking target, exists within the central region CC, the travel potential field generation unit 3 acquires the position of the preceding vehicle in the input image as the reference object information, and sets a low-potential point, which serves as the endpoint of the target route, at a position determined based on the position of the preceding vehicle. Therefore, according to the vehicle control device 1, a travel potential field that allows the vehicle to automatically follow a preceding vehicle can be generated through simple computation performed on the input image.

(7) In a case where the vehicle is traveling on a road where the sky is blocked by an overhead structure, such as inside a tunnel—that is, in a situation where the sky is scarcely visible in the input image—the travel potential field generation unit 3 acquires, as the reference object information, the position of the road boundary line or the position of the preceding vehicle recognized as a tracking target, and sets a low-potential point at a position determined based on the road boundary line or the position of the preceding vehicle. Therefore, according to the vehicle control device 1, even in a case where the sky is not sufficiently visible in the input image, the low-potential point can be set at an appropriate position.

(8) The travel potential field generation unit 3 sets the value of the travel potential such that, within the low-potential range centered on the low-potential point, the gradient becomes steeper as the position approaches the center; within the first high-potential range centered on the first high-potential point, the gradient likewise becomes steeper as the position approaches the center; and, outside the low-potential range and the first high-potential range, the gradient is constant and more gradual than within the respective ranges. According to the vehicle control device 1, a travel potential field can be generated through simple computation, in such a manner that the resulting field generates a target route which avoids the first high-potential point, where an obstacle exists, and terminates at the low-potential point.

(9) The travel potential field generation unit 3 sets a second high-potential point in a region of the input image where a lane marking of the vehicle V appears. The travel potential field generation unit 3 sets the value of the travel potential at the second high-potential point to a third set value greater than the first set value, and generates the travel potential field by interpolating the values of the travel potential, in the region between the low-potential point and the second high-potential point in the input image, using values between the first set value and the third set value. Therefore, according to the vehicle control device 1, a travel potential field can be generated through simple computation, in such a manner that the resulting field induces a target route which avoids a first high-potential point where an obstacle exists and a second high-potential point where a lane marking exists, and terminates at a low-potential point.

(10) As described above, by setting a second high-potential point at a position where the lane marking of the vehicle V exists, a target route that avoids the lane marking is generated. Accordingly, when the vehicle V is currently performing or is scheduled to perform a lane change, the travel potential field generation unit 3 is configured not to set the second high-potential point as described above. Therefore, according to the present invention, it is possible to generate, through simple computation, a travel potential field so that a target route crossing a lane marking can be generated.

While the embodiment of the present invention has been described above, the present invention is not limited to the embodiment described herein. Various modifications may be made to the detailed configuration within the scope and spirit of the present invention.

What is claimed is:

1. A vehicle control device, comprising:
an input image acquirer configured to acquire, as an input image, an image captured by a camera directed forward as viewed from a host vehicle;
a travel potential field generator configured to generate a travel potential field indicating a distribution of travel potential with respect to a future travel position of the host vehicle, based on the input image;
a target trajectory generator configured to generate a target trajectory of the host vehicle, based on a gradient of the travel potential in the travel potential field; and
a travel controller configured to operate a steering mechanism, based on the target trajectory,
wherein the travel potential field generator is configured to execute the processing of:
extracting, from the input image, reference object information regarding a position of a reference object or a boundary of the reference object;
setting a low-potential point at a position within a central region of the input image, the position being determined based on the reference object information;
identifying, in the input image, a position of an obstacle that obstructs safe travel of the host vehicle;
setting a first high-potential point in a region of the input image where the obstacle appears;
setting a value of the travel potential at the low-potential point to a first set value;
setting a value of the travel potential at the first high-potential point to a second set value greater than the first set value; and
generating the travel potential field by interpolating the value of the travel potential, in a region between the low-potential point and the first high-potential point in the input image, using a value between the first set value and the second set value.

2. The vehicle control device according to claim 1,
wherein the travel potential field generator is configured to:
acquire, as the reference object information, a position of a fitting line of a left-sky boundary line, and a position of a fitting line of a right-sky boundary line, in the input image; and
set the low-potential point at an intersection point of the fitting line of the left-sky boundary line and the fitting line of the right-sky boundary line, in a case where the intersection point exists within the central region.

3. The vehicle control device according to claim 1,
wherein the travel potential field generator is configured to:
acquire, as the reference object information, a position of a fitting line of a left-road boundary line, and a position of a fitting line of a right-road boundary line, in the input image; and
set the low-potential point at an intersection point of the fitting line of the left-road boundary line and the fitting line of the right-road boundary line, in a case where the intersection point exists within the central region.

4. The vehicle control device according to claim 1,
wherein the travel potential field generator is configured to:
acquire, as the reference object information, a position of a road boundary line in the input image; and
set the low-potential point at a topmost point of the road boundary line in the input image, in a case where the topmost point exists within the central region.

5. The vehicle control device according to claim 1,
wherein the travel potential field generator is configured to:
acquire, as reference object information, a position of a left-sky fitting line of a left-sky boundary line in the input image, a position of a right-sky fitting line of a right-sky boundary line in the input image, a position of a left-road fitting line of a left-road boundary line in the input image, a position of a right-road fitting line of a right-road boundary line in the input image, and a position of a road boundary line in the input image; and
set the low-potential point at a position determined based on two or more points that exist within the central region, the points including: an intersection point of the left-sky fitting line and the right-sky fitting line, an intersection point of the left-road fitting line and the right-road fitting line, and a topmost point of the road boundary line in the input image.

6. The vehicle control device according to claim 1, wherein the travel potential field generator is configured to:
acquire, as the reference object information, a position of a preceding vehicle in the input image, in a case where the preceding vehicle is recognized as a tracking target within the central region.

7. The vehicle control device according to claim 1, wherein the travel potential field generator is configured to:
acquire, as the reference object information, a position of a road boundary line or a position of a preceding vehicle recognized as a tracking target, in a case where the host vehicle is traveling on a road where the sky is blocked by an overhead structure.

8. The vehicle control device according to claim 1, wherein the travel potential field generator is configured to:
set the value of the travel potential such that a gradient becomes steeper as approaching the low-potential point within a low-potential range centered on the low-potential point;
set the value of the travel potential such that a gradient becomes steeper as approaching the first high-potential point within a first high-potential range centered on the first high-potential point; and
set the value of the travel potential such that a gradient outside the low-potential range and the first high-potential range is constant and more gradual than inside the low-potential range and the first high-potential range.

9. The vehicle control device according to claim 1, wherein the travel potential field generator is configured to further execute the processing of:
identifying a position of a lane marking of the host vehicle in the input image;
setting a second high-potential point in a region of the input image where the lane marking appears;
setting a value of the travel potential at the second high-potential point to a third set value greater than the first set value; and
generating the travel potential field by interpolating a value of the travel potential, in a region between the low-potential point and the second high-potential point in the input image, using a value between the first set value and the third set value.

10. The vehicle control device according to claim 9, wherein the travel potential field generator is configured not to set the second high-potential point in a case where the host vehicle is performing or scheduled to perform a lane change.

11. A vehicle control method for controlling a host vehicle by a computer based on an image captured by a camera directed forward as viewed from the host vehicle, the method comprising the steps of:
acquiring, as an input image, an image captured by the camera;
generating a travel potential field indicating a distribution of travel potential with respect to a future travel position of the host vehicle, based on the input image;
generating a target trajectory of the host vehicle, based on a gradient of the travel potential in the travel potential field; and
operating a steering mechanism, based on the target trajectory,
wherein the step of generating the travel potential field includes the processing of:
extracting, from the input image, reference object information regarding a position of a reference object or a boundary of the reference object;
setting a low-potential point at a position within a central region of the input image, the position being determined based on the reference object information;
identifying, in the input image, a position of an obstacle that obstructs safe travel of the host vehicle;
setting a first high-potential point in a region of the input image where the obstacle appears;
setting a value of the travel potential at the low-potential point to a first set value;
setting a value of the travel potential at the first high-potential point to a second set value greater than the first set value; and
generating the travel potential field by interpolating a value of the travel potential, in a region between the low-potential point and the first high-potential point in the input image, using a value between the first set value and the second set value.

12. A non-transitory computer-readable storage medium storing a program for controlling a host vehicle by a computer, based on an image captured by a camera directed forward as viewed from the host vehicle,
wherein the program causes the computer to execute the steps of:
acquiring, as an input image, an image captured by the camera;
generating a travel potential field indicating a distribution of travel potential with respect to a future travel position of the host vehicle, based on the input image;
generating a target trajectory of the host vehicle, based on a gradient of the travel potential in the travel potential field; and
operating a steering mechanism, based on the target trajectory;
wherein the step of generating the travel potential field includes causing the computer to execute the processing of:
extracting, from the input image, reference object information regarding a position of a reference object or a boundary of the reference object;
setting a low-potential point at a position within a central region of the input image, the position being determined based on the reference object information;
identifying, in the input image, a position of an obstacle that obstructs safe travel of the host vehicle;
setting a first high-potential point in a region of the input image where the obstacle appears;
setting a value of the travel potential at the low-potential point to a first set value;
setting a value of the travel potential at the first high-potential point to a second set value greater than the first set value; and
generating the travel potential field by interpolating a value of the travel potential, in a region between the low-potential point and the first high-potential point in the input image, using a value between the first set value and the second set value.
